(19) United States
(12) Patent Application Publication
(10) Pub. No.: US 2006/0195391 A1
(43) Pub. Date: Aug. 31, 2006

(54) Modeling loss in a term structured financial portfolio

(76) Inventor: Evan J. Stanelle, San Diego, CA (US)

Correspondence Address: Paul E Schaafsma;Suite 221, 521 West Superior Street, Chicago, IL, 60610-3135, US

(21) Appl. No.: 11/326,769

(22) Filed: Jan. 6, 2006

Related U.S. Application Data
(60) Provisional application No. 60/714,522, filed on Feb. 28, 2005.

(51) Int. Cl. G06Q 40/00

(52) U.S. Cl. 705/38

(57) ABSTRACT

In accordance with the principles of the present invention, an apparatus, simulation method, and system for modeling loss in a term structured financial portfolio are provided. An historical date range, time unit specification, maturity duration, evaluation horizon, random effects specification, and set of portfolio covariates are selected. Historical data is then segmented into infinitely many cumulative loss curves according to a selected covariate predictive of risk. The s-shaped curves are modeled according to a nonlinear kernel. Nonlinear kernel parameters are regressed against time units up to the maturity duration and against selected portfolio covariates. The final regression equations represent the central moment models necessary for prior distribution specification in the hierarchical Bayes model to follow. Once the hierarchical Bayes model is executed, the finite samples generated by a Metropolis-Hastings within Gibbs sampling routine enable the inference of net dollar loss estimation and corresponding variance. In turn, the posterior distributions enable the risk analysis corresponding to lifetime loss estimates for routine risk management, the valuation of derivative financial instruments, risk-based pricing for secondary markets or new debt obligations, optimal holdings, and regulatory capital requirements. Posterior distributions and analytical results are dynamically processed and shared with other computers in a global network configuration.

### FIELD OF THE INVENTION

The present invention relates to risk management.

### BACKGROUND OF THE INVENTION

Large financial institutions are required to manage credit risk in a way that garners net positive returns and that protects creditors, insurance finds, taxpayers, and uninsured depositors from the risk of bankruptcy. In a first scenario, an understanding of credit risk is used to generate pricing for debt obligations, securitizations, and portfolio sales. In a second scenario, credit risk is used to set the regulatory capital requirements necessary for large, internationally active banking organizations. Accordingly, there are a myriad of tools used to help an institution evaluate, monitor, and manage the risk within a financial portfolio. The majority of these tools are proprietary asset based models that monitor manifest risk in the portfolio according to the mixture of credit ratings associated with each loan.

Such prior art asset value models include J.P Morgan's CreditMetrics available from J.P. Morgan Chase, 270 Park Avenue, New York, N.Y. 10017; Moody's KMV Portfolio Manager available from Moody's Investors Service, Inc., 99 Church Street, New York, N.Y. 10007; and Credit Suisse Financial Product's CreditRisk+ available from Credit Suisse First Boston, Eleven Madison Avenue, New York, N.Y. 10010. See Gupton, G. M., Finger, C. C. & Bhatia, M., “Introduction to CreditMetrics,” J.P. Morgan & Co., Incorporated (1997); Kealhofer, S., “Apparatus and Method for Modeling the Risk of Loans in a Financial Portfolio, U.S. Pat. No. 6,078,903 (1998); and CreditRisk+—A Credit Risk Management Framework,” Credit Suisse Financial Products (1997). See also Makivic, M. S., “Simulation Method and System for the Valuation of Derivative Financial Instruments,” U.S. Pat. No. 6,061,662 (2000). These industry models admit a definition for risk, transition probabilities, and a process of asset values. The process of asset values is of prime importance since an institutions chance for survival is seen as the probability that the process will remain above a certain threshold at a given planning horizon. This correlation between multiple processes within a portfolio is known as the asset correlation. The signal characteristic of CreditMetrics and KMV Portfolio Manager has been their respective handling of asset correlations, with the main difference between the two being one of equity verses debt modeling. In fact, the original technical document associated with CreditMetrics has influenced if not guided the correlation calculations in the newly proposed Basel Accord. See Basel Committee on Banking Supervision, “The New Basel Capital Accord: Third Consultative Paper,” Bank of International Settlements (2003). (Available from: http://www.bis.org/bcbs/bcbscp3.htm.) CreditRisk+ takes an actuarial approach that considers all information about correlations to be embedded in the default rate volatilities.

Nonetheless, these industry models, albeit comprehensive in their respective approach, either require substantial a priori input for accurate financial analysis (for example, CreditMetrics and KMV Portfolio Manager) or ignore the stochastic term structure of interest rates and the nonlinear effects inherent to large portfolios (for example, CreditRisk+). (For a discussion on the notable strengths and weaknesses of each model, see Jarrow, R. A. & Turnbull, S. M. “The intersection of market and credit risk.” 24 Journal of Banking and Finance 271-299 (2000).) Accurately modeling default frequencies, transition probabilities (high migration probabilities for KMV Portfolio Manager and historic rating changes for CreditMetrics), and global industry risk factors (or sectors for CreditRisk+) is a difficult task. As a result, the accuracy of the final analysis depends on the availability and accuracy of input values. Running multiple scenarios with varying input assumptions over time can provide a convergence of agreement with regard to analysis. New regulatory capital requirements, however, now demand an empirical statement of risk that even the best industry models have yet to provide outright.

Therefore, it would be highly desirable to increase the flexibility and empiricism of financial portfolio risk evaluation without disregarding the complexities of transition probability and asset value dynamics. Increasing the flexibility and empiricism of financial portfolio risk evaluation without disregarding the complexities of transition probability and asset value dynamics would have a positive influence on internal risk management practices, the valuation of derivative financial instruments, and the management of regulatory capital.

### SUMMARY OF THE INVENTION

A method in accordance with the principles of the present invention increases the flexibility and empiricism of financial portfolio risk evaluation without disregarding the complexities of transition probability and asset value dynamics. By increasing the flexibility and empiricism of financial portfolio risk evaluation without disregarding the complexities of transition probability and asset value dynamics, a method in accordance with the principles of the present invention can positively influence internal risk management practices, the valuation of derivative financial instruments, and the management of regulatory capital.

In accordance with the principles of the present invention, a simulation method is executed on a computer or network of computers under the control of a program. An historical date range, time unit specification, a maturity duration, and set of portfolio covariates are selected for an historical set of term structured loans. Information about the loans can be proprietary, public or purchased from a vendor. Financial data is stored in a computer or on a storage medium. Historical data is then segmented into infinitely many cumulative loss curves according to a selected covariate predictive of risk. The curves are modeled according to a nonlinear kernel. Each of the nonlinear kernel parameters is regressed against time units up to the maturity duration and against selected portfolio covariates. The final regression represents the central moment models necessary for prior distribution specification in the hierarchical Bayes model to follow. An evaluation horizon is selected for an active population of loans.

An hierarchical Bayes model is executed once input is defined and the cumulative loss curves are formatted. The model is solved using a Markov Chain Monte Carlo (MCMC) method known as a Metropolis-Hastings within Gibbs sampling routine. Infinitely many iterations of the routine produce a posterior distribution for each parameter. The finite samples enable inference of point estimation for each of the parameters. In addition, a posterior distribution is created for net dollar loss at the evaluation horizon.

Different forms of risk analysis can be performed once the posterior distributions are created. One embodiment of the invention creates a net dollar loss forecast and corresponding credible region for any time less than or equal to the maturity duration. Such a utility applies to standard risk management practices. Another embodiment compares the loss assumptions inherent to the risk-based pricing policies selected at input with the empirical loss estimates and credible regions for each policy segment produced. Such a utility applies to the calibration of risk-based pricing for secondary markets and new debt obligations. Another embodiment monitors the rate of loss growth with respect to time, thus describing the mixture of risk within the portfolio and, in turn, providing the utility to calculate optimal holdings. Another embodiment uses the asymptotic variance of forecast error to calculate an upper bound estimate of unexpected loss. This upper bound of unexpected loss is used for managing regulatory capital requirements.

### BRIEF DESCRIPTION OF THE FIGURES

FIG. 1 illustrates an example of a general purpose computer set up to execute a method in accordance with the principles of the present invention.

FIG. 2 illustrates an example of a global network configuration of a method in accordance with the principles of the present invention.

FIG. 3 illustrates processing steps that can be used to implement a method in accordance with the principles of the present invention.

FIG. 4 illustrates the tracking of portfolio loss growth in accordance with the principles of the present invention by three broad credit grades.

FIG. 5 illustrates the coverage of an arbitrarily defined state space for a subprime, term structured portfolio.

FIG. 6 illustrates the modeling of unexpected loss in accordance with the principles of the present invention for a validation sample of asset backed securities.

FIG. 7 illustrates the modeling of expected loss in accordance with the principles of the present invention for a validation sample of asset backed securities.

FIG. 8 illustrates the hypothetical V-statistic characterization of risk growth in accordance with the principles of the present invention for a validation sample of asset backed securities.

### DETAILED DESCRIPTION OF AN EMBODIMENT

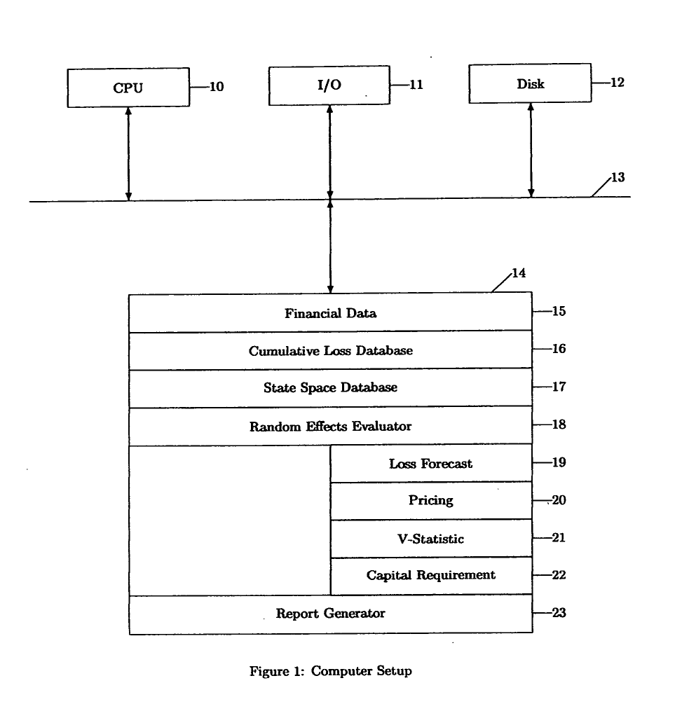

Referring to FIG. 1, an example of a suitable setup of a general desktop computer or server to execute a method in accordance with the principles of the present invention is seen. Well known in the art, the construction can consist of a central processing unit (CPU) 10, input/output (I/O) components 11, storage medium such as a disk 12, a bus 13, and memory 14. Input/output (I/O) components 11 may include standard devices such as a keyboard, printer, monitor, and mouse. The disk 12 can represent any device that writes and stores data, such as for example an internal or external hard drive, zip disk, tape cartridge, etc. The CPU 10 interacts with the other components over the bus 13. The interactions by such components are well known in the art. Accordingly, the present invention is focused on the operation of these elements with respect to a set of specialized data stored on disk, the use of this data within a program stored in memory, and the communication of data and results within a global network of computers.

In accordance with the principles of the present invention, memory 14 can include: portfolio data 15; a cumulative loss database 16; a state space database 17; a random effects evaluator 18; analytical modules 19-22; and a report generator 23. Portfolio data 15 can include: demographic data; account/performance data; and financial data. Demographic data are data that specifically describe the borrower associated with a loan liability. Demographic data are used as covariates within a segmentation technique in accordance with the principles of the present invention. Demographic data can also be used as covariates within the regression technique used to develop central moment estimates for prior distribution specification in the hierarchical Bayes model; in this capacity, the main function of demographic covariates is to increase accuracy when there is limited performance data available on an active portfolio or portfolio segment. Account/performance data can include data that describe a loan (for example, origination amount, annual percentage rate, term, payment history, default history, exposure given default, etc.). Account data are used in the same way as demographic data; performance data, however, can contain the charge-off event indicator and the corresponding exposure amount at charge-off.

Financial data can include data that characterizes the operational and financial costs of the servicer associated with originating, servicing, and carrying an exposure to an evaluation horizon. Financial data also can include the loss given that a loan charges-off prior to the evaluation horizon. Performance data and financial data are used to create cumulative loss curves that can be stored in the cumulative loss database 16 and on disk 12.

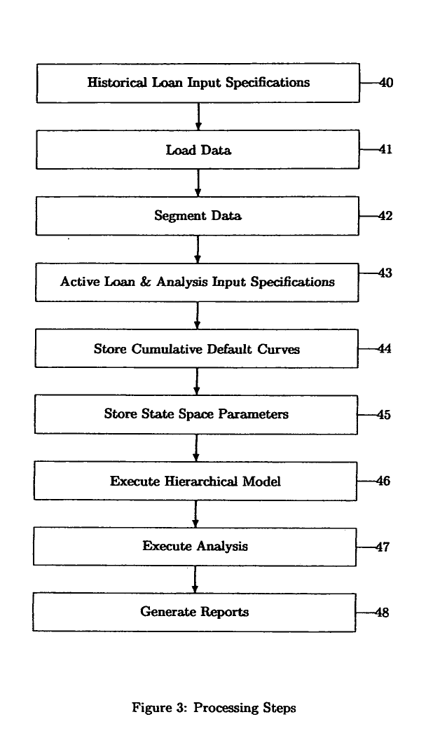

In contrast to the prior art, a method in accordance with the principles of the present invention does not explicitly require risk influences such as country, industry or business risk as data input. In addition, the underlying correlations among assets are not directly required on the front-end of analysis since portfolio loss is not managed at the asset level within the present invention. This follows from the following principle: an evolving cumulative loss curve will contain and make manifest risk influences and correlations inherent to its process according to the path it follows. A method in accordance with the principles of the present invention uses portfolio data 15, though commonly used within the art, in a radically different way by examining the aggregated behavior of loss rather than the interaction of individual asset components. This alternate approach will be discussed in more detail with reference to FIG. 3.

The cumulative loss database 16 is a sub-component of the portfolio management database known within the art. The cumulative loss database 16, however, contains net dollar loss curves aggregated into segments specified by user input rather than asset-level information. Accordingly, the cumulative loss database 16 acts as a staging area: conventional programming techniques can be used to retrieve data from a formal data system, perform audit checks, and prepare the input for model evaluation within the state space processor 17. The final output is a series of s-shaped curves that can be divided into a set consisting of mature loans and a set consisting of active loans. The set of mature loan curves will have the same unit of time duration as specified by the user. The active loan segments will represent the same number of curves as the unit of time used to measure a loan to maturity. For example, an active 60-month termed portfolio evaluated according to a monthly time unit will have 60 active curves. The curves may be written to disk 12 or output using the report generator 23.

In conjunction with the principle that an evolving cumulative loss curve will contain and make manifest risk influences and correlations inherent to its process according to the path it follows, if the stochastic changes in portfolio loss are constrained by the s-shape of cumulative loss growth, then the dynamics of a portfolio can be described according to the parameters of the corresponding nonlinear kernel. Fitting this nonlinear kernel proceeds by re-expressing the differential equation:

$$\frac{ⅆ P}{ⅆ t} = P ( \frac{{a}_{0}}{{t}^{2}} )$$

where P and t denote cumulative loss and time, respectively. The above equation can thus be written as:
P(t)=e^{(-a}^{ₒ}^{/t+a}^{ᵢ}⁾
Consequently, the state space processor 17 acts as a processing area for the set of mature s-shaped loss curves. Analytical or numerical methods, which may be of the type known in the art, are first used to solve for the two free parameters in the second equation. The resulting set of parameters (equal to two times the number of segments) explains the set of historical curves and, thus, describes the transition probabilities or state space of loss growth.

A second processing step then regresses each parameter, in turn, according to the model:
ƒ(L_{b}aᵢ)
where Lₜ denotes cumulative loss at each time t=0, . . . , d for the collection of curves in the state space; d equals the common maturity duration; and aᵢ denotes the collection of fit parameter values for the parameter space. The resulting set of equations (equal to two times d) represents prior distributions describing state space transition probabilities. The prior distribution equations can be prepared as file input to the random effects evaluator 18 and, along with the state space parameters, can be written to disk 12.

The random effects evaluator 18 executes the hierarchical Bayes model associated with the invention. The random effects evaluator 18 fits evolving portfolio performance of active loans with the prior distribution equations calculated by the state space processor 17. This is done by executing a Markov Chain Monte Carlo (MCMC) method known as a Metropolis-Hastings within Gibbs Sampling algorithm. This algorithm is well known in the art and may be executed by a network of computers to decrease overall processing time. The random effects evaluator 18 also can include modules used for: forecasting loss 19; determining pricing 20; monitoring loss growth 21; and calculating a capital requirement. The random effects evaluator 18 and each of its modules 19-22 will be discussed in more detail with reference to FIG. 3.

Lastly, the report generator 23 can be used to create output for the input/output (I/O) devices 11. The report generator 23 can output any warnings produced by the cumulative loss database 16 as well as the results of the separate random effects evaluator modules 19-22. The report generator 23 also can write static output files to disk. These files can be read by other computers constructed as in FIG. 1 and may be used in conjunction with the other state space data written to disk by the cumulative loss database 16 and the state space processor 17.

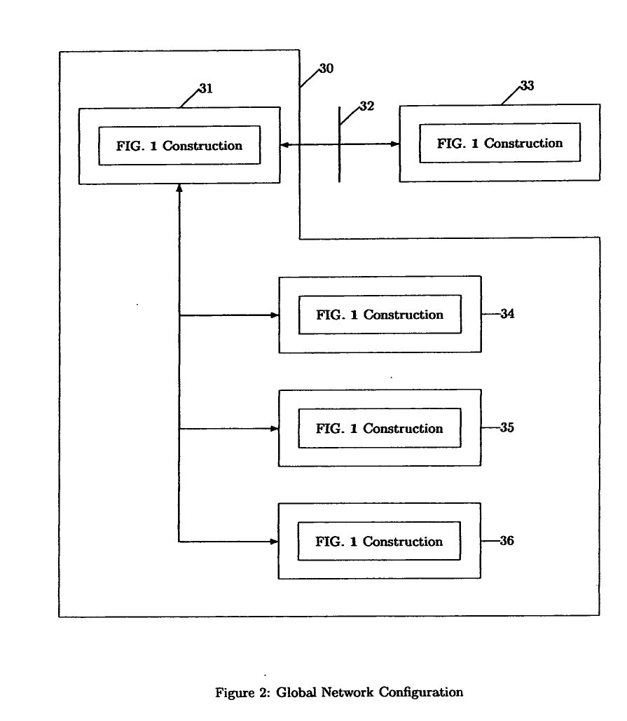

FIG. 2 illustrates an example of a global network configuration of computers (which can include desktop computers and servers constructed as in FIG. 1). The global network can consist of computers connected by a local area network (LAN) 30, a LAN computer connected to a wide area network such as the Internet 31, a firewall 32, and a computer 33 connected to the LAN via the wide area network. The series of computers connected to the LAN 34-36 represent 1^{st}, 2^{nd}, and n^{th} computers in the network, respectively. The configuration of such a network and the interaction between each component is well known in the art. The present invention is, therefore, directed towards how the processing related to the program stored in memory 14 is shared across processors, and how the output from the components 15-23 is collectively shared across computers.

For simplicity, it is shown that the LAN computer connected to the Internet 31 is a master server executing the program stored in memory 14. The main purpose of this server 31 is to provide the necessary database interface connections with an internal computer 34-36 or external computer 33 to collect and collate transactional or static system data as well as data possibly provided by an external vendor. These connections are realized upon executing the retrieval of portfolio data 15. This type of interface connection may be of the type well known in the art. The master server 31 can also contain a scheduler that is used to automate the connections to the data sources and is used to automate the execution of the program in memory 14. The time unit of automation represents the frequency of state space processing desired.

The Markov Chain Monte Carlo (MCMC) methods inherent to the random effects evaluator 18 are computationally expensive. Accordingly, the program in memory 14 for the master server 31 may be shared with other processors 33-36. This reduces overall processing time and, as will be discussed, produces more desirable results which, upon completion, may be reduced to the master server 31 and, in turn, shared with the wide area network. Since empirical knowledge of a loss curve is exhaustive up to its most recent time unit (as implied in the principle that an evolving cumulative loss curve will contain and make manifest inherent risk influences and correlations according to the path it follows), the frequency of state space updates is positively correlated with the amount of near term effects contained within an evolving curve. Rather than requiring different latent variable scenarios or simulating such scenarios with a broader update interval as in the prior art, the present invention accepts the exhaustive nature of an empirical loss curve with the challenge of continuous updates.

Therefore, the master server 31 can be scheduled to execute the program in memory 14 in a distributed fashion across the LAN 30 and with external computers 33. The collected results of the random effects evaluator 18 can be shared with the global network in FIG. 2 to direct the processing of other analytical programs operating in memory on any one of the computers. An automated underwriting program on an external computer 33, for example, may be approving a near term shift in riskier loans with prices that are not adequately adjusted. In most cases, the risk on these loans is not recognized unless the correct assumptions about present random effects are considered (which are not validated until for example 8-12 months post origination). Routine state space evaluations, however, can detect the multidimensional changes early on (within for example 3 months) and may make automated changes to the underwriting program to increase (decrease) prices commensurate with the near term manifestation of increased (decreased) risk.

FIG. 3 illustrates processing steps that can be used to implement a method in accordance with the principles of the present invention. The input 40 necessary for historical state space processing 17 is specified. In addition to an historical and contiguous date range, time unit specification, and maturity duration, input can include demographic/account and financial covariates as well.

The contiguous date range may be any range prior to the current evaluation time; however, it is advantageous to include the largest possible range the data repository will allow. A date range that covers both economic recessionary and growth periods will produce a greater diversity of state space curves and, thus, more robust output. The time unit represents the scale used to analyze loss growth. Accordingly, the maturity duration may vary from 1 to d units of time provided that d is less than the units of time when subtracting the minimum date, min, from the maximum date, max, in the contiguous range. The process is aborted if the constraint d<(max−min) is not met.

Demographic/account and financial covariates represent the information accepted for segmentation and cumulative loss calculation, respectively. The demographic and account information is supplied in the form of a preselected covariate. The covariate is highly predictive of a default event and may be identified by statistical methods known in the art. The financial information can include any number of covariates related to the financial loss defined in the newly proposed Basel Accord (Basel Committee on Banking Supervision, “The New Basel Capital Accord: Third Consultative Paper,” Bank of International Settlements (2003)) that are not already accounted for by the exposure value at charge-off.

Next, mature and active portfolio data 41 pulled from system sources per historical input specifications 40 is stored. Depending on the size of the contiguous date range selected, data may be too large to store in memory 14 and can, thus, be stored on disk 12. Once stored, the historical data can be segmented according to one of the demographic/account or financial covariates supplied at input 40.

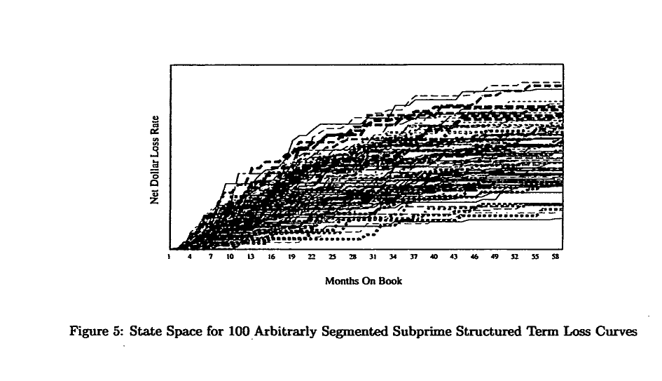

Next, loans 42 are segmented into infinitely many groups. The segmentation is into mature and active loans as previously discussed. The mature loans, however, are further segmented by rank ordering the population of loans by the specified demographic/account covariate. The loans are divided into covariate ranges that include a minimum number, for example at least 50 units of severe default or charge-off per segment; this segmentation will later produce a diversity of curves following the same kernel structure as an aggregate portfolio loss curve. FIG. 5 shows a sample of such curves. A diversity of curves is desirable since it represents the multidimensional risk and economic scenarios affecting loss growth.

Next, the evaluation horizon and the number of modules to run for portfolio analysis are selected. The first selection is accepted as active loan input 43 but is not utilized until execution of the hierarchical model 45. Likewise, the selection of modules is not used until final analysis. Therefore, they will be discussed further below.

Next, the historical and active cumulative default curves 44 are stored according to the respective segment definitions and financial calculations previously defined at input 40, 43. Values for each parameter in the nonlinear kernel of
P(t)=e^{(-a}^{ₒ}^{/t+a}^{ᵢ}⁾
are regressed against Lₜ for each time t=0, . . . , d according to the general model of ƒ(L_{b}aᵢ) and applicable input 40, 43 and the resulting collection of state space parameters 45 are stored

Next, the hierarchical Bayes model 46 is executed. Let S and X denote the cumulative dollar loss rate and the growth in dollar loss rate at time t, respectively, such that Sₜ=X₁+ . . . +Xₜ. Since a method in accordance with the present invention is attempting to predict the series of values to follow t for a portfolio or portfolio segment, the expectation of the next period Sₜ₊₁ is taken:

$$\begin{matrix}E [ {S}_{t + 1} \text{\vert} {S}_{t} ] = E [ {S}_{t} + {X}_{t + 1} \text{\vert} {S}_{t} ] \\ = {S}_{t} + E [ {X}_{t + 1} \text{\vert} {X}_{1} , … , {X}_{t} ] \\ = {g}_{St} ( t + 1 )\end{matrix}$$

where g_{S}_{ₜ}(t+1) denotes the nonlinear kernel
exp(αₙ/(t+1)+βₙ)
fit with Xₜ values up to a known time n. As such, g_{S}_{ₜ}(t+1) possesses a deterministic property since Xₜ₊₁ completely depends on X₁, . . . , Xₜ at will lead to the same lifetime loss estimate once initialized. It is also clear that the prediction error when forecasting from t will increase as t becomes small.

To avoid the determinism inherent to g_{S}_{ₜ}(t+1), let
Φ=(g¹(T),g²(T), . . . , g^{m}(T))
be an (l×m) vector of loss curves having the same term l over time T and where
g^{m}(T)=exp(α^{(m)})/t+β^{(m))}
with specified parameters α^{(m)} and β^{(m)} for the m^{th} curve in Φ. If the random variables
α=(α⁽¹⁾,α⁽²⁾, . . . , α^{(m)} and
β=(β⁽¹⁾,β⁽²⁾, . . . , β^{(m)})
are mutually independent, then additional functions ƒ(S_{b}α) and ƒ(Sₜ,β)(previously denoted as ƒ(Lₜaᵢ)) exist such that
αₙ˜N(ƒ(Sₜ,α),σ²) and
βₙ˜N(ƒ(Sₜβ),γ²),
where N(a, b) denotes a normal distribution with mean a and precision b. Accordingly, the k-step expectation following t becomes

$$E [ {S}_{t + k} \text{\vert} {S}_{t} ] = exp ( \frac{{a}_{n}}{t + k} + {β}_{n} ) ,$$

where k=1, 2, 3, . . . . With repeated sampling for αₙ, and βₙ, the lifetime loss estimate is no longer deterministic as in g_{S}_{ₜ}(t+1) but possesses the Markov properties necessary for Bayesian estimation of Sₜ₊ₖ at time t.

Therefore, the probabilistic interactions contained within the random effects evaluator are described by the likelihood terms:
xₜ˜N(μₜ,τ),
μₜ=exp(α/t+β),
αₙ˜N(ƒ(Sₜ,α),τ_{α}),
βₙ˜N(Sₜ,β),τ_{β}).
To complete the probability model, a non-informative Gamma prior is chosen for each of the precision hyperparameters such that
τ,τ_{α},τ_{β}˜Ga(0.001,0.001),
where Ga(a, b) denotes a gamma distribution with shape parameter a, scale parameter b, mean a/b and variance a/2.

Given that the parameters for a model are known in closed form, the full conditional distribution for a parameter θ will be proportional to the product of its likelihood and stated prior distribution:
P({θᵢ|θ_{i≠j}},x)∝P(x|θ)π(θ)≡L(θ)π(θ).
Accordingly, the problem of nonconjugate distributions, such as the sampling distributions for parameters α and β becomes a “univariate version of the basic computation problem of sampling from nonstandardized densities. ” See Carlin, B. P. & Louis, T. A., “Bayes and Empirical Bayes Methods for Data Analysis,” Chapman & Hall/CRC, Boca Raton, Fla. (2000). As such, the full conditional for α can be specified as

$$P ( α \text{\vert} \cdot ) ∝ exp [ - \frac{1}{2} \{ ( {\sum }_{t = 1}^{n} {τ ( {x}_{t} - {ⅇ}^{α / t + β} )}^{2} ) + {{τ}_{α} ( α - f ( {S}_{n} , α ) )}^{2} \} ] .$$

The full conditional distribution for β is analogous to the above equation with (β−ƒ(Sₙ,β))² and τ_{β} replacing (α−ƒ(Sₙ,α))² and τ_{α} respectively. The full conditional distribution for τ, on the other hand, is specified by its conjugate, gamma distribution:

$$P ( τ \text{\vert} \cdot ) ∝ {τ}^{( n / 2 + α ) - 1} ⨯ exp [ - τ \{ \frac{{\sum }_{t = 1}^{n} {( {x}_{t} - {ⅇ}^{α / t + β} )}^{2}}{2} + b \} ] ,$$

with shape parameter n/2+α and scale parameter:

$${\{ \frac{{\sum }_{t = 1}^{n} {( {x}_{t} - {ⅇ}^{α / t + β} )}^{2}}{2} + b \}}^{- 1} .$$

Similar to the derivation of the conjugate, gamma distribution for τ, above, the full conditional for each parameter τ_{α} and τ_{β} conjugate Gamma distribution with shape parameter ½+α and a scale parameter

$${( \frac{{θ}_{i}^{2}}{2} + b )}^{- 1}$$

where θ₁α and θ₂=β.

Returning to FIG. 3, the next processing step solves the parameters in the full probability model for each active vintage by completing multiple iterations of the Metropolis-Hastings within Gibbs sampling routine. A full sampling routine creates a posterior distribution of independent samples for parameters and calculations within the full probability model. The independent samples are an important and attractive result of the current invention. Carlin & Louis note that the approximation will be poor if α and β are highly correlated since this will lead to high autocorrelation in the resulting β⁽ⁱ⁾ sequence. (Carlin, B. P. & Louis, T. A., “Bayes and Empirical Bayes Methods for Data Analysis,” Chapman & Hall/CRC, Boca Raton, Fla. (2000)) Analysis analogous to the example provided herein has shown that α and β are, indeed, highly correlated within a single chain (Pearson r=−0.930, p<0.001). Accordingly, distributed computing of the hierarchical Bayes model reduces the processing overhead and creates independent and identically distributed (i.i.d.) samples for each parameter without a significant increase in run-time when compared to preferred methods within the art such as ergodic sampling run on a signal processor. (Carlin & Louis). The i.i.d. posterior distribution samples for each parameter can be stored on disk 12 and in memory 14 and can be used within the analysis performed by modules 19-22.

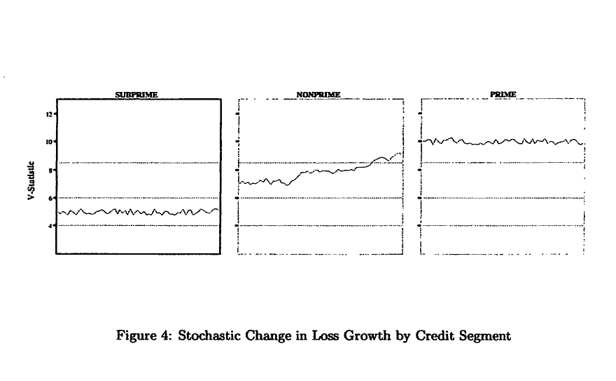

Next, portfolio analysis 47 is executed using the modules selected as input 43. Each preferred embodiment will be discussed in turn with some modules making reference to FIGS. 4-5.

The loss forecast module 19 performs point estimation of cumulative loss at the evaluation horizon p specified by input 43. An estimate for lifetime loss at p is achieved by calculating the mean or median for the vector of posterior loss estimates Y. Given the known performance for an active vintage at time n,
Y_{(l×m)}=exp(αₙⱼ/p+βₙⱼ)
for j=1, 2, . . . , m; where m denotes the number of hierarchical Bayes sampling iterations. The resulting posterior density for Y provides direct computation of the desired lifetime loss estimate as well as a region of credibility for the estimate at p. Accordingly, to create point estimates for cumulative portfolio loss, the loss estimates for each active vintage are weight aggregated against each vintage's original balance to produce an i.i.d sample of cumulative portfolio loss at p for each hierarchical Bayes sampling iteration. The loss forecast module 19 calculates common point estimates such as the mean and median as well as the order statistics related to the i.i.d portfolio sample. Results can be output to the report generator 23 and saved to disk 12.

The pricing module 20 compares the loss assumptions inherent to the risk-based pricing policies selected at input 43 with the empirical loss estimates and credible regions for each policy segment produced by the random effects evaluator 18. Pricing policies make assumptions about future loss that fall within a certain standard deviation of the empirical distribution. The pricing module 20 compares each assumption with its deviation from the expected lifetime loss estimate. Loss assumptions in relation to point estimates, standard deviations, and the posterior distribution of empirical loss is output to the report generator 23 and saved to disk 12.

The V-Statistic module 21 calculates the variation in loss growth as a function of time and segment specification selected at input 43. The s-shaped curve of a cumulative loss curve, modeled according to the nonlinear kernel in equation
P(t)=e^{(-a}^{ₒ}^{/t+a}^{ᵢ}⁾
above, demonstrates its maximum rate of growth when t=a₀/2. This value, denoted as v, is a statistic that generally defines the stochastic change in credit quality for a single vintage. That is, large values for v indicate reduced risk growth and, hence, better credit quality. An aggregate description of credit quality for the entire portfolio is calculated by taking the expected value of v across active vintages according to the equation:

$$V = \frac{1}{2} {\sum }_{k = a}^{N} {α}_{kn} w ( k ) ,$$

where N denotes the number of vintages, n the known performance month for vintage k, and w(k) the ratio of origination volume for vintage k to total portfolio volume such that

$${\sum }_{k = 1}^{N} w ( k ) = 1.$$

FIG. 4 illustrates V-Statistic output 21 calculated over a 12-week interval and displayed according to three broad credit grades. The dashed horizontal lines are arbitrary specifications marking the thresholds for upper and lower loss growth necessary for maintaining optimal holdings. The V-Statistic output 21 provides the utility of identifying portfolio segments that have shown increased or decreased loss growth approaching or moving beyond operationally defined thresholds (for example, the non-prime segment). This module provides V-Statistic estimation up to the most recent time unit available and may be refreshed according to the scheduler specification managed by the master server 31.

The capital requirement module 22 calculates the unexpected loss distribution at the evaluation horizon as a function of the error in asymptotic forecast accuracy. Let E denote the random variable for the portfolio net lifetime loss forecast divided by the actual lifetime loss. Note that E is distributed according to a Normal distribution with mean μ=1 and variance σ² since the actual lifetime loss is a constant. The quantity

$$\frac{\overline{E} - μ}{S / \sqrt{n}}$$

has Student's t distribution with n−1 degrees of freedom and is, typically, the assumed distribution when sampling from a Normal distribution with unknown variance. Also note that the distribution of unexpected loss, described by the absolute error of the state space forecast, |t₍ₙ₋₁₎|, approaches the absolute value of a standard normal distribution in the limit:

$${lim}_{n \to ∞} \vert {t}_{( n - 1 )} \vert \to \vert Z \vert$$

As such, the expected value and variance for the asymptotic distribution of unexpected loss is
E|Z|=\sqrt{2/π}
and Var|Z|=1−2/π=0.3634, respectively.

Let v² denote the variance of unexpected loss described above. Assuming that the weight of unexpected loss, ε, is distributed as Gamma(a,b) with expected value=a/b and variance a/b², the capital requirement module 22 uses v² to calculate values for a and b. Adopting a Gamma distribution as a model for ε is justified since its value cannot be less than zero. Likewise, a Gamma distribution allows for a positively skewed distribution of error that we would expect under conditions of severe economic shock To maintain probabilistic symmetry from the sampling of E, the module sets \tilde{e}, the median value of ε˜Gamma(a,b), to 1 such that the probability of overestimating loss is equal to the probability of underestimating loss at any given iteration of the sampling routine. The capital requirement module 22 is then able to solve for the values of a and b given the constraints that a/b²=v² and that
∫₀ⁱGamma(a,b)=0.50.
Provided ε˜ƒ(e|a,b) exists, the unexpected portfolio loss is calculated as

$$\hat{L} = {\sum }_{j = 1}^{m} {\sum }_{k = 1}^{N} {l}_{jk} w ( k ) {e}_{j} ,$$

where m denotes the number of hierarchical Bayes sampling iterations and N, k and w denote the respective values recited in

$$V = \frac{1}{2} {\sum }_{k = a}^{N} {α}_{kn} w ( k ) ,$$

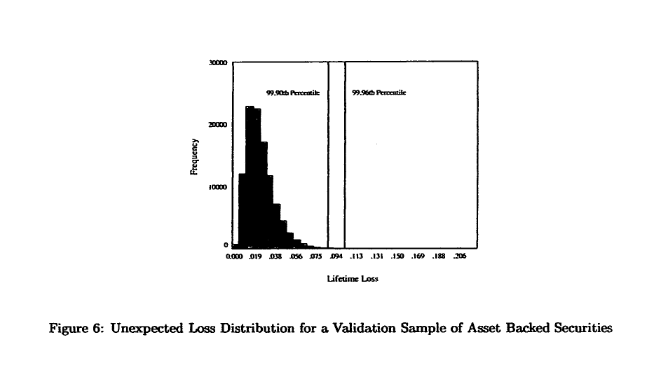

FIG. 6 illustrates 100,000 samples of unexpected loss generated according to the logic of the above equation and having ε˜Gamma(a=3.366025, b=3.043534). The posterior distribution of \hat{L} provides a convenient method for determining capital holdings since the probability of \hat{L} is simply a function of its order statistics. FIG. 6, for example, shows a 0.001 probability that net lifetime loss will exceed 8.95%.

The capital requirement module 22 produces a distribution of net loss and corresponding summary statistics according to the evaluation horizon and random effects specification selected at input 43. Results can be output to the report generator 23 and saved to disk 12. Upper percentiles of unexpected loss may then be used to calculate capital according to regulatory requirements.

Reports 48 can be generated using the output from other processing steps. The reports may be output to I/O devices 11 or saved to disk 12. The following provides an illustrative, non-limiting example of a portfolio analysis of asset backed securities undertaken in accordance with the principles of the present invention

### EXAMPLE

A portfolio analysis of asset backed securities has been undertaken in accordance with the principles of the present invention. In this example, the data set was divided into test and validation samples both containing mature and active securitizations. The results for the test sample are compared with the empirical values of the validation sample in terms of prediction accuracy. The capital requirement determined by the present invention is compared with the requirements put forth by the New Basel Accord.

The data set includes auto loan securitization performance as of 30 Jun. 2004 as listed by ABSNet available from Lewtan Technologies, Inc., 300 Fifth Avenue, Waltham, Mass. 02451. There were 124 securities having at least 40 months of net loss performance information, of which 80% or more of the values were valid (that is, not null or less than zero). The weighted average coupon (WAC) of this set was distributed bimodally with modes of 9% and 19%. This reflects the lending practices of prime/non-prime and subprime financing, respectively. The sub-prime securities were excluded since they constituted a smaller portion of the set, were represented by only a couple lenders, and operate according to different business practices than their prime counterpart. The final analytical file contained 77 securities and was randomly divided into 60-count development and 17-count validation samples.

Hypothetically, the development and validation samples represent the respective historical and active liabilities information of diverse vintages for an active finance or banking institution. As such, data was loaded and cumulative default curves were generated according to processing steps 40-45 in FIG. 3. The state space information 17 was then used by the random effects evaluator 18 to produce a forecast of lifetime net loss and derivative capital requirements for the validation sample.

Table 1 presents the actual 36-month loss performance and corresponding state space forecast for the validation sample. (The tables are set forth in the Appendix) The majority of securitizations had a maturity duration of 48 months; very few actually had reached maturity, however. In addition, over 90% of the total net loss was accounted for by month 36. Accordingly, the 36 month evaluation period noted here was used because it enabled a larger, more diverse sample without compromising the scenario of a lifetime forecast. The loss forecast module 19 combined the development sample information with the first six months of performance for each securitization in the validation sample. The final forecast is reported as a percent and a currency per securitization; a weighted total forecast is also included. The individual forecasts demonstrate a variability of expected difference centered close to 0.00%. This results in a total 36-month portfolio loss forecast of $410.2MM that is only a −0.04% difference and a −2.72% underestimate of the actual loss of $421.7MM. An analysis of a subprime vintage-based portfolio showed similar results with a −0.02% difference and a −0.10% underestimate of actual loss.

The hierarchical simulation considers possible correlations of the inherent asset population. Accordingly, the forecast estimates in Table 1 include the asset correlations underlying the portfolio. Unlike CreditMetrics and KMV Portfolio Manager, where asset correlation is determined given a priori constraints, the hierarchical evaluation of structured term loss considers distributions of default, severity, and asset correlation to be exhaustively specified by the repeated sampling from an historical state space of cumulative loss curves integrated with the empirical loss of an active vintage or security. See Kealhofer, S. “Apparatus and Method for Modeling the Risk of Loans in a Financial Portfolio” U.S. Pat. No. 6,078,903; Gupton, G. M., Finger, C. C. & Bhatia, M. “Introduction to CreditMetrics.” J. P. Morgan & Co., Incorporated (1997). The hierarchical model, in fact, requires minimal inputs while retaining the characteristics of term structure of interest rates and the incorporation of nonlinear influences in its s-shaped cumulative model. There is, therefore, a comprehensive set of advantages in the current invention—a full consideration of stochastic effects (like CreditMetrics and KMV Portfolio Manager) requiring minimal a priori input (like CreditRisk+)—that does not characterize any one of the current industry models.

Table 2 presents the expected 36-month loss forecast vis-à-vis initial credit support for each securitization in the validation sample. The three shaded securitizations were covered by a 100% surety bond so the support value was replaced with the group median value; the remaining securitizations were either supported by cash reserves, a spread account, over-collateralization or a combination of these three. Admittedly, it is unfair to compare the 36-month forecast directly with the initial support figures. First, the 36-month period does not accurately reflect the maturity duration presumed to be used in the original credit derivative evaluation. Second, the support figures can vary in absolute values depending on derivative liquidity and, thus, may not be synonymous with the expected loss derived from stress testing. However, assuming that each securitization is commensurate in risk (that is, they are characterized as prime/non-prime loans), the support values have been averaged and then discounted by 8.38% (that is, empirical loss at month 36 is 91.62% of the loss at month 48) to replicate the total portfolio support and, in turn, the expected loss for a 36 month maturity duration.

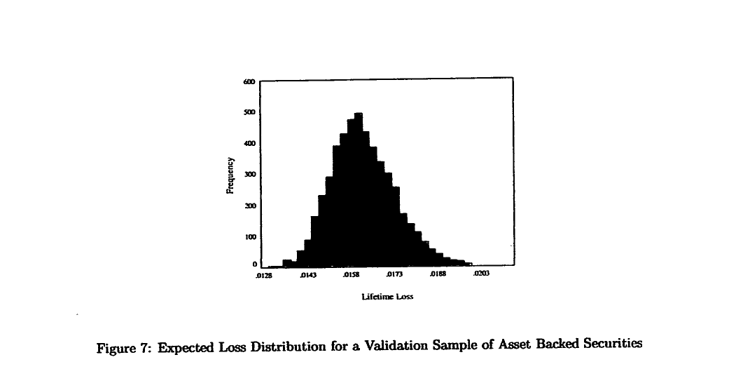

FIG. 7 shows the posterior distribution of expected 36-month loss. Notably, all of the samples are less than 2.12%. This suggests that, given at least the first six months of performance for any one securitization, the total expected 36-month portfolio loss will be less than 2.12% almost 100% of the time. This is not radically different from the 2.84% average of initial support, suggesting that, indeed, the current portfolio of securitizations has been adequately supported However, the 2.12% value represents the uppermost bound of the 1.52% loss expected. It is, therefore, reasonable to consider reducing the initial support to a value equivalent to the posterior upper bound after routine performance evaluation of the portfolio as been completed at month six. It is also possible (and more likely) that the present results could be used to demonstrate adequate capital management, thus, enabling a financial institution access to other credit markets. See Jackson, P., Perrandin, W. Saporta, V, “Regulatory and ‘economic’ solvency standards for internationally active banks.” 26 Journal of Banking and Finance 953-976 (2002).

Another extension of the results in Table 2 and FIG. 7 is to evaluate loss assumptions undergirding pricing policies. Most banks and financial institutions rely on risk-based pricing guidelines that assume that historical losses by a similar group of obligors will follow in the future for new obligors possessing the same demographic and credit characteristics. In such a case, a lifetime loss calculation of moderate confidence usually requires at least 12-18 months of performance. The current invention, however, provides both a robust expected loss estimate and a posterior distribution of loss by month six. Accordingly, the 2.12% upper bound, in comparison to the 2.84% assumption under a consumer pricing scenario, would suggest a gross overstatement within the risk-based pricing guidelines. In such a case, the financial institution would have empirical justification for reducing prices.

Table 3 presents the marginal v-statistic values for each securitization in the validation sample. Except for the first listed, the v-statistic value for all securitizations ranges between 9 and 12. There are two ways to leverage this statistic. The cumulative value (denoted with a capital V) can be calculated across time for a fixed or growing portfolio. In the former case, the V-statistic provides a visual supplement to the expected loss and posterior distribution calculations discussed previously since its value, plotted over time, indicates the change in expected loss. The utility of the V-statistic, however, is better recognized in the latter case when monitoring a growing portfolio. In such a scenario, the V-statistic provides an empirical method for monitoring optimal holdings.

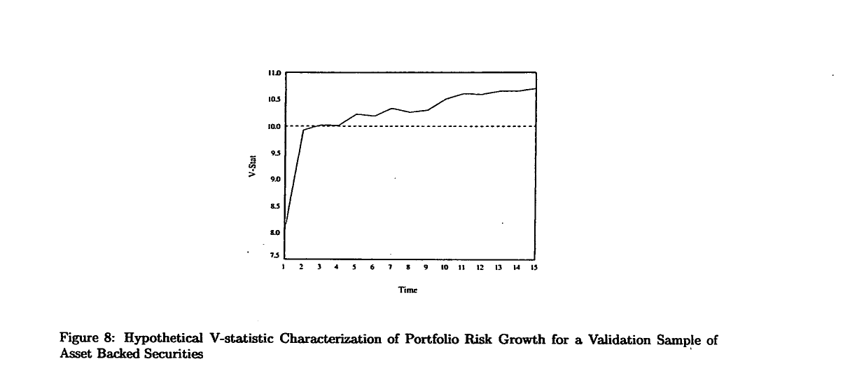

FIG. 8 shows the hypothetical risk evolution of a financial portfolio over consecutive time units (usually reported in months). The current data set does not allow a formal demonstration of V-statistic utility; however, FIG. 8 demonstrates a consecutive increase in the V-statistic for the validation sample when its elements are considered as contiguous vintages. In this scenario, the V-statistic process shows a small, increasing trend that describes a decrease in overall portfolio risk growth. The operational threshold shown in FIG. 8 is arbitrarily chosen (as are the values in FIG. 4) to highlight the flexibility in setting thresholds and managing to a strategy of optimal holdings.

Table 4 presents the capital requirements for the validation sample as set forth by the New Basel Accord. A probability of default (PD) estimate of 1.36% was derived by dividing the cumulative net loss (in dollars) for each securitization in the development sample by its average loan amount, taking the difference between the corresponding values at month 12 and month 24 divided by the total units at month 12, and then averaging this value across the entire sample. A loss-given-default (LGD) estimate of 54.38% was calculated by simply averaging the reported severity measure for each securitization across the entire development sample. The exposure-at-default (EAD) estimate was the total outstanding principle balance for the validation sample. And Basel components—correlation (R), capital requirement (K), risk weighted assets (RWA)—were calculated according to the “other retail exposure” formulas in the new Basel Accord. When evaluated at the twelfth month of performance, the final regulatory capital requirement was 8.948% of the EAD or $2,410MM.

FIG. 6 presents the capital requirements as determined by the random effects evaluator 18 of the present invention. The first twelve months of performance for each securitization in the validation set was sampled with the historical state space according to an asymptotic error variance distributed as Gamma(a=3.66025, b=3.043534). FIG. 6 characterizes the variance of extreme unexpected loss with its skewed distribution of samples. Interestingly, the 99.90^{th} percentile of the posterior distribution indicates an 8.945% requirement that is almost identical to the Basel calculation in Table 4. The weighted net loss at the 12-month evaluation horizon, however, is 0.0755%. Subtracting this from 8.945% results in a requirement of 8.8695% that, in turn, represents a $21.1MM savings in capital holdings.

The threshold between the 99.90^{th} and the 99.96^{th} percentiles in FIG. 6 represents the range where we would expect the actual capital holdings to exist Jackson et al. note that most finance and banking institutions exceed the regulatory solvency standards, analogous to the 99.00^{th} and the 99.90^{th} percentile range, to maintain access to swap and interbank markets. Indeed, the Basel calculation of the present exercise represents the upper bound of survival probabilities allowed by its method. Accordingly, the present validation results may not suggest a savings in capital holdings but, instead, may suggest that the institution concerned with maintaining immediate access to credit markets actually increase their holdings.

While the invention has been described with specific embodiments, other alternatives, modifications and variations will be apparent to those skilled in the art. Accordingly, it will be intended to include all such alternatives, modifications and variations set forth within the spirit and scope of the appended claims.

TABLE 1
Actual 36-month loss performance and corresponding state space
forecast for the validation sample.

| | | | | % Cumulative | % Cumulative |
|---|---|---|---|---|---|
| | Closing | | | Loss At | Loss At |
| Seller/Servicer | Date | Original Balance | WAC | Month 6 | Month 36 |
| Chrysler Financial | 1999, March | $1,359,367,000 | 9.11% | 0.07% | 1.35% |
| Wells Fargo | 1996, November | $1,064,746,000 | 9.79% | 0.01% | 0.76% |
| Mellon | 2000, March | $351,261,000 | 9.41% | 0.04% | 1.74% |
| Franklin Capital Corporation | 2001, January | $139,087,000 | 12.40% | 0.16% | 3.40% |
| Ford Motor Credit Company | 2001, March | $3,997,826,000 | 8.89% | 0.06% | 2.03% |
| Ford Motor Credit Company | 2001, January | $3,200,002,000 | 8.57% | 0.06% | 1.69% |
| Ford Motor Credit Company | 2000, September | $2,999,995,000 | 8.27% | 0.05% | 1.52% |
| Ford Motor Credit Company | 2000, June | $2,999,970,000 | 7.95% | 0.05% | 1.44% |
| Ford Motor Credit Company | 1998, May | $3,000,000,000 | 11.00% | 0.13% | 1.39% |
| Ford Motor Credit Company | 1996, June | $1,043,323,000 | 11.07% | 0.25% | 2.48% |
| First Security Bank, N.A. | 1999, May | $1,032,351,000 | 9.95% | 0.13% | 2.02% |
| First Security Bank, N.A. | 1998, October | $749,746,000 | 10.39% | 0.13% | 1.34% |
| First Security Bank, N.A. | 1998, April | $500,000,000 | 10.63% | 0.09% | 1.52% |
| Chrysler Financial | 2001, March | $1,974,999,000 | 6.74% | 0.05% | 1.39% |
| Continental Auto Receivables | 2000, October | $155,261,000 | 11.57% | 0.16% | 4.28% |
| Corp. | | | | | |
| Chase | 2000, December | $1,280,466,000 | 9.75% | 0.03% | 1.02% |
| Chase | 1998, June | $1,094,800,000 | 8.99% | 0.04% | 0.65% |
| | | $26,943,200,000 | | | 1.57% |

| | % Cumulative | % State Space | $ State Space | | |
|---|---|---|---|---|---|
| | Loss At | Forecast At | Forecast At | Relative | Expected |
| | Month 36 | Month 36 | Month 36 | Difference | Difference |
| Chrysler Financial | $18,351,455 | 1.45% | $19,772,673 | 0.10% | 0.01% |
| Wells Fargo | $8,092,070 | 1.38% | $14,717,984 | 0.62% | 0.02% |
| Mellon | $6,111,941 | 1.39% | $4,873,746 | −0.35% | 0.00% |
| Franklin Capital Corporation | $4,728,958 | 1.88% | $2,613,792 | −1.52% | −0.01% |
| Ford Motor Credit Company | $81,155,868 | 1.45% | $57,786,576 | −0.58% | −0.09% |
| Ford Motor Credit Company | $54,080,034 | 1.47% | $47,070,429 | −0.22% | −0.03% |
| Ford Motor Credit Company | $45,599,924 | 1.37% | $41,026,432 | −0.15% | −0.02% |
| Ford Motor Credit Company | $43,199,568 | 1.48% | $44,480,555 | 0.04% | 0.00% |
| Ford Motor Credit Company | $41,700,000 | 1.68% | $50,272,500 | 0.29% | 0.03% |
| Ford Motor Credit Company | $25,874,410 | 2.20% | $22,953,628 | −0.28% | −0.01% |
| First Security Bank, N.A. | $20,853,490 | 1.72% | $17,794,634 | −0.30% | −0.01% |
| First Security Bank, N.A. | $10,046,596 | 1.80% | $13,497,677 | 0.46% | 0.01% |
| First Security Bank, N.A. | $7,600,000 | 1.55% | $7,772,750 | 0.03% | 0.00% |
| Chrysler Financial | $27,452,486 | 1.53% | $30,178,972 | 0.14% | 0.01% |
| Continental Auto Receivables | $6,645,171 | 1.88% | $2,917,509 | −2.40% | −0.01% |
| Corp. | | | | | |
| Chase | $13,060,753 | 1.39% | $17,796,557 | 0.37% | 0.02% |
| Chase | $7,116,200 | 1.34% | $14,664,846 | 0.69% | 0.03% |
| | $421,668,924 | 1.52% | $410,191,261 | | −0.04% |
| | $421,668,924 | − | $410,191,261 | = | −$11,477,663 |
| | | | | | −2.72% |

TABLE 2
Expected 36-month loss forecast vis-à-vis initial
credit support for each securitization in the validation sample.

| | | Initial Support | Forecast |
|---|---|---|---|
| | Closing | for 48-Month | for 36-Month |
| Seller/Servicer | Date | Maturity | Maturity |
| Chrysler Financial | 1999, March | 4.09% | 1.45% |
| Wells Fargo | 1996, November | 1.75% | 1.38% |
| Mellon | 2000, March | 2.62% | 1.39% |
| Franklin Capital | 2001, January | 2.62% | 1.88% |
| Corporation | | | |
| Ford Motor Credit | 2001, March | 2.73% | 1.45% |
| Company | | | |
| Ford Motor Credit | 2001, January | 3.45% | 1.47% |
| Company | | | |
| Ford Motor Credit | 2000, September | 5.18% | 1.37% |
| Company | | | |
| Ford Motor Credit | 2000, June | 6.16% | 1.48% |
| Company | | | |
| Ford Motor Credit | 1998, May | 2.50% | 1.68% |
| Company | | | |
| Ford Motor Credit | 1996, June | 2.90% | 2.20% |
| Company | | | |
| First Security Bank, | 1999, May | 2.50% | 1.72% |
| N.A. | | | |
| First Security Bank, | 1998, October | 2.50% | 1.80% |
| N.A. | | | |
| First Security Bank, | 1998, April | 2.50% | 1.55% |
| N.A. | | | |
| Chrysler Financial | 2001, March | 6.04% | 1.53% |
| Continental Auto | 2000, October | 2.62% | 1.88% |
| Receivables Corp. | | | |
| Chase | 2000, December | 1.00% | 1.39% |
| Chase | 1998, June | 1.50% | 1.34% |
| | 48 mo | 3.10% | N/A |
| | Adjusted 36 mo | 2.84% | 2.12%^{a} |

^{a}Value represents the upper bound of the posterior distribution for expected loss.

TABLE 3
Marginal v-statistic values for each securitization
in the validation sample.

| | Closing | Original Balance | | Alpha | Marginal |
|---|---|---|---|---|---|
| Seller/Servicer | Date | (000) | WAC | Estimate | v-stat |
| Ford Motor Credit Company | 1996, June | $1,043,323,000 | 11.07% | −16.06 | 8.03 |
| Wells Fargo | 1996, November | $1,064,746,000 | 9.79% | −23.59 | 11.79 |
| First Security Bank, N.A. | 1998, April | $500,000,000 | 10.63% | −20.85 | 10.43 |
| Ford Motor Credit Company | 1998, May | $3,000,000,000 | 11.00% | −20.03 | 10.02 |
| Chase | 1998, June | $1,094,800,000 | 8.99% | −22.51 | 11.26 |
| First Security Bank, N.A. | 1998, October | $749,746,000 | 10.39% | −19.92 | 9.96 |
| Chrysler Financial | 1999, March | $1,359,367,000 | 9.11% | −22.14 | 11.07 |
| First Security Bank, N.A. | 1999, May | $1,032,351,000 | 9.95% | −19.33 | 9.66 |
| Mellon | 2000, March | $351,261,000 | 9.41% | −22.88 | 11.44 |
| Ford Motor Credit Company | 2000, June | $2,999,970,000 | 7.95% | −22.43 | 11.22 |
| Ford Motor Credit Company | 2000, September | $2,999,995,000 | 8.27% | −22.01 | 11.01 |
| Continental Auto Receivables Corp. | 2000, October | $155,261,000 | 11.57% | −18.32 | 9.16 |
| Chase | 2000, December | $1,280,466,000 | 9.75% | −23.23 | 11.61 |
| Franklin Capital Corporation | 2001, January | $139,087,000 | 12.40% | −18.75 | 9.38 |
| Ford Motor Credit Company | 2001, January | $3,200,002,000 | 8.57% | −21.44 | 10.72 |
| Ford Motor Credit Company | 2001, March | $3,997,826,000 | 8.89% | −21.67 | 10.83 |
| Chrysler Financial | 2001, March | $1,974,999,000 | 6.74% | −21.93 | 10.96 |
| | | $26,943,200,000 | | | |

TABLE 4
Capital requirements for the validation sample as
set forth by the New Basel Accord.

| | Closing | | | | |
|---|---|---|---|---|---|
| Seller/Servicer | Date | Original Balance | WAC | EAD | PD |
| Chrysler Financial | 1999, March | $1,359,367,000 | 9.11% | $1,358,844,312 | 1.36% |
| Wells Fargo | 1996, November | $1,064,746,000 | 9.79% | $1,064,534,554 | 1.36% |
| Mellon | 2000, March | $351,261,000 | 9.41% | $350,453,576 | 1.36% |
| Franklin Capital Corporation | 2001, January | $139,087,000 | 12.40% | $137,016,468 | 1.36% |
| Ford Motor Credit Company | 2001, March | $3,997,826,000 | 8.89% | $3,996,616,306 | 1.36% |
| Ford Motor Credit Company | 2001, January | $3,200,002,000 | 8.57% | $3,199,437,231 | 1.36% |
| Ford Motor Credit Company | 2000, September | $2,999,995,000 | 8.27% | $2,999,347,540 | 1.36% |
| Ford Motor Credit Company | 2000, June | $2,999,970,000 | 7.95% | $2,999,305,145 | 1.36% |
| Ford Motor Credit Company | 1998, May | $3,000,000,000 | 11.00% | $2,999,319,040 | 1.36% |
| Ford Motor Credit Company | 1996, June | $1,043,323,000 | 11.07% | $1,041,517,708 | 1.36% |
| First Security Bank, N.A. | 1999, May | $1,032,351,000 | 9.95% | $1,030,727,016 | 1.36% |
| First Security Bank, N.A. | 1998, October | $749,746,000 | 10.39% | $749,058,714 | 1.36% |
| First Security Bank, N.A. | 1998, April | $500,000,000 | 10.63% | $499,070,979 | 1.36% |
| Chrysler Financial | 2001, March | $1,974,999,000 | 6.74% | $1,974,397,944 | 1.36% |
| Continental Auto Receivables | 2000, October | $155,261,000 | 11.57% | $153,961,898 | 1.36% |
| Corp. | | | | | |
| Chase | 2000, December | $1,280,466,000 | 9.75% | $1,280,051,258 | 1.36% |
| Chase | 1998, June | $1,094,800,000 | 8.99% | $1,094,441,408 | 1.36% |
| | | | | $26,928,101,094 | 1.36% |

| | LGD | R | K | RWA | CAP REQ |
|---|---|---|---|---|---|
| Chrysler Financial | 54.38% | 11.32% | 8.95% | $1,519,866,493 | $121,589,319 |
| Wells Fargo | 54.38% | 11.32% | 8.95% | $1,190,681,217 | $95,254,497 |
| Mellon | 54.38% | 11.32% | 8.95% | $391,982,100 | $31,358,568 |
| Franklin Capital Corporation | 54.38% | 11.32% | 8.95% | $153,252,832 | $12,260,227 |
| Ford Motor Credit Company | 54.38% | 11.32% | 8.95% | $4,470,212,780 | $357,617,022 |
| Ford Motor Credit Company | 54.38% | 11.32% | 8.95% | $3,578,568,495 | $286,285,480 |
| Ford Motor Credit Company | 54.38% | 11.32% | 8.95% | $3,354,768,304 | $268,381,464 |
| Ford Motor Credit Company | 54.38% | 11.32% | 8.95% | $3,354,720,885 | $268,377,671 |
| Ford Motor Credit Company | 54.38% | 11.32% | 8.95% | $3,354,736,427 | $268,378,914 |
| Ford Motor Credit Company | 54.38% | 11.32% | 8.95% | $1,164,936,889 | $93,194,951 |
| First Security Bank, N.A. | 54.38% | 11.32% | 8.95% | $1,152,867,507 | $92,229,401 |
| First Security Bank, N.A. | 54.38% | 11.32% | 8.95% | $837,821,692 | $67,025,735 |
| First Security Bank, N.A. | 54.38% | 11.32% | 8.95% | $558,210,570 | $44,656,846 |
| Chrysler Financial | 54.38% | 11.32% | 8.95% | $2,208,362,836 | $176,669,027 |
| Continental Auto Receivables | 54.38% | 11.32% | 8.95% | $172,206,284 | $13,776,503 |
| Corp. | | | | | |
| Chase | 54.38% | 11.32% | 8.95% | $1,431,736,513 | $114,538,921 |
| Chase | 54.38% | 11.32% | 8.95% | $1,224,132,014 | $97,930,561 |
| | 54.38% | 11.32% | 8.95% | $30,119,063,840 | $2,409,525,107 |

What is claimed is:

1. A simulation method comprising:
inputting historical data of loans;
inputting demographic, account and financial data of loans; and
segmenting the loans into multiple groups, the groups including mature and active loans, the mature loans further segmented by the demographic or account data.

2. The method of claim 1 further wherein the step of inputting historical data of loans comprises inputting an contiguous date range, time unit specification, and maturity duration.

3. The method of claim 2 further wherein the step of inputting demographic, account, and financial data of loans comprises inputting data representing the borrower associated with a loan liability, data representing the specific loan liability of the borrower, and data representing the operational and financial costs associated with originating, servicing, and carrying a loan to a specified evaluation horizon.

4. The method of claim 3 further comprising the steps of:
generating a loss forecast at the evaluation horizon input;
generating a loss forecast at the maturity time input and comparing the forecast with pricing assumptions derived from account data input;
calculating the variation in loss growth according to time unit and segment input, the loss growth calculated by solving the second derivative for each portfolio curve with respect to time;
calculating the unexpected loss distribution at the evaluation horizon as a function of calculated asymptotic forecast error;
integrating the nonlinear kernel for an active curve with solved parameters to derive a default frequency distribution; and
generating reports and graphs characterizing the loss forecasts for mature and active loans, generating reports and graphs characterizing the loss forecast for active loans in comparison to pricing assumptions, generating reports and graphs characterizing the variation in loss growth, generating reports and graphs characterizing the unexpected loss distribution at the evaluation horizon, and generating reports and graphs characterizing the default frequency distribution.

5. The method of claim 1 further comprising the step of storing active loan and analysis input in the computer, the input including an evaluation horizon and specific modules to run for analysis.

6. The method of claim 1 further comprising the step of generating default curves according to the respective input.

7. The method of claim 6 further comprising the step of generating a posterior sampling distribution of nonlinear kernel parameters and equivalents for each mature curve using a Metropolis-Hastings within Gibbs sampling algorithm.

8. The method of claim 6 further comprising generating reports and graphs illustrating cumulative default growth.

9. A method for modeling loss in a term structured financial portfolio comprising:
executing a simulation method;
selecting historical data of loans; and
segmenting the historical data into cumulative loss curves according to a selected covariate predictive of risk.

10. The method for modeling loss in a term structured financial portfolio of claim 9 further wherein the step of selecting historical data comprises selecting an historical and contiguous date range, time unit specification, and maturity duration.

11. The method for modeling loss in a term structured financial portfolio of claim 10 further including selecting an evaluation horizon and set of portfolio covariates.

12. The method for modeling loss in a term structured financial portfolio of claim 9 further including segmenting historical data into infinitely many cumulative loss curves according to a selected covariate predictive of risk

13. The method for modeling loss in a term structured financial portfolio of claim 9 further including modeling s-shaped curves according to a nonlinear kernel.

14. The method for modeling loss in a term structured financial portfolio of claim 13 further including regressing the nonlinear kernel parameters against time units up to the maturity duration and against selected portfolio covariates.

15. The method for modeling loss in a term structured financial portfolio of claim 14 further including executing an hierarchical Bayes model where the final regression equations represent the central moment models necessary for prior distribution specification in the hierarchical Bayes model.

16. The method for modeling loss in a term structured financial portfolio of claim 15 further including, once the hierarchical Bayes model is executed, enabling the inference of net dollar loss estimation and corresponding variance from the finite samples generated by a Metropolis-Hastings within Gibbs sampling routine.

17. The method for modeling loss in a term structured financial portfolio of claim 9 further including enabling the risk analysis corresponding to lifetime loss estimates for routine risk management, the valuation of derivative financial instruments, risk-based pricing for secondary markets or new debt obligations, optimal holdings, and regulatory capital requirements from the posterior distributions.

18. A computer readable memory that can be used to direct a computer to perform a simulation method, comprising:
a module that enables historical input to be input in the computer;
a module that enables demographic, account and financial data to be input in the computer; and
a module that segments loans into multiple groups, the groups including mature and active loans, the mature loans further segmented by the demographic or account data.

19. The computer readable memory of claim 18 further wherein the module that enables historical input to be input in the computer further comprises allowing an contiguous date range, time unit specification, and maturity duration to be input.

20. The computer readable memory of claim 18 further comprising a module that enables active loan and analysis to be input in the computer, the input including an evaluation horizon and specific modules to run for analysis.

21. The computer readable memory of claim 18 further comprising a module that enables default curves, defined according to the nonlinear kernel of cumulative loss, to be generated according to the respective input and stored in the computer.

22. The computer readable memory of claim 21 further comprising a module that enables the generation of a posterior sampling distribution of nonlinear kernel parameters and equivalents for each mature curve using a Metropolis-Hastings within Gibbs sampling algorithm.

23. The computer readable memory of claim 22 further wherein the module that enables the generation of a posterior sampling distribution of nonlinear kernel parameters and equivalents for each mature curve using a Metropolis-Hastings within Gibbs sampling algorithm further comprises enabling the posterior distribution samples and posterior distribution sample statistics for each parameter and curve to be stored in the computer.

24. The computer readable memory of claim 241 further comprising a module that enables the generation of reports and graphs characterizing posterior sampling statistics for each active curve.

25. A method for modeling loss in a term structured financial portfolio comprising examining the aggregated behavior of loss rather than the interaction of individual asset components correlated with the amount of near term effects contained within an evolving curve.

26. A method for modeling loss in a term structured financial portfolio comprising accepting the exhaustive nature of an empirical loss curve with the challenge of continuous updates rather than requiring different latent variable scenarios or simulating such scenarios with a broader update interval.
